(19) United States
(12) Patent Application Publication
(10) Pub. No.: US 2009/0200315 A1
(43) Pub. Date: Aug. 13, 2009

(54) SET OF PLASTIC EATING AND/OR DRINKING AIDS

(76) Inventor: Etienne Herman Walter Blondeel, Terheijden (NL)

Correspondence Address: HOFFMANN & BARON, LLP, 6900 JERICHO TURNPIKE, SYOSSET, NY, 11791, US

(21) Appl. No.: 12/302,041

(22) PCT Filed: May 23, 2007
(86) PCT No.: PCT/NL07/50239

§ 371 Date: Mar. 6, 2009

(30) Foreign Application Priority Data
May 23, 2006 (NL) 1031862
Oct. 5, 2006 (NL) 1032633
Dec. 15, 2006 (NL) 1033065
Feb. 16, 2007 (NL) 1033411
Mar. 5, 2007 (NL) 1033488

(51) Int. Cl. A47G 19/02; A47J 43/28; B29C 45/13

(52) U.S. Cl. 220/574.1; 30/322; 30/324; 264/328.8

(57) ABSTRACT

A plastic set (1) of eating and/or drinking aids, comprising eating and/or drinking aids (3, 4, 5) and connecting pieces (6), wherein the eating and/or drinking aids (3, 4, 5) are breakably inter coupled by means of the connecting pieces (6), preferably wherein the eating and/or drinking aids (3, 4, 5) are included in a relatively flat condition with respect to one another and intersect substantially one imaginary intersecting plane.

The invention relates to a set of plastic eating and/or drinking aids.

It is common to use separate disposable cutlery and disposable plates, for instance for picnics, barbecues and/or in flying. Drawbacks are that, before and after use, the plates and the cutlery need to be collected and kept together and that, further, separate units often need to be stored separately.

At least one of above-mentioned drawbacks and/or other drawbacks can be obviated with a set of plastic eating and/or drinking aids according to the invention, comprising eating and/or drinking aids and connecting pieces, wherein the eating and/or drinking aids are breakably intercoupled by means of the connecting pieces.

To clarify the invention, exemplary embodiments of a set of eating and/or drinking aids according to the invention will be explained in more detail with reference to the drawing, in which:

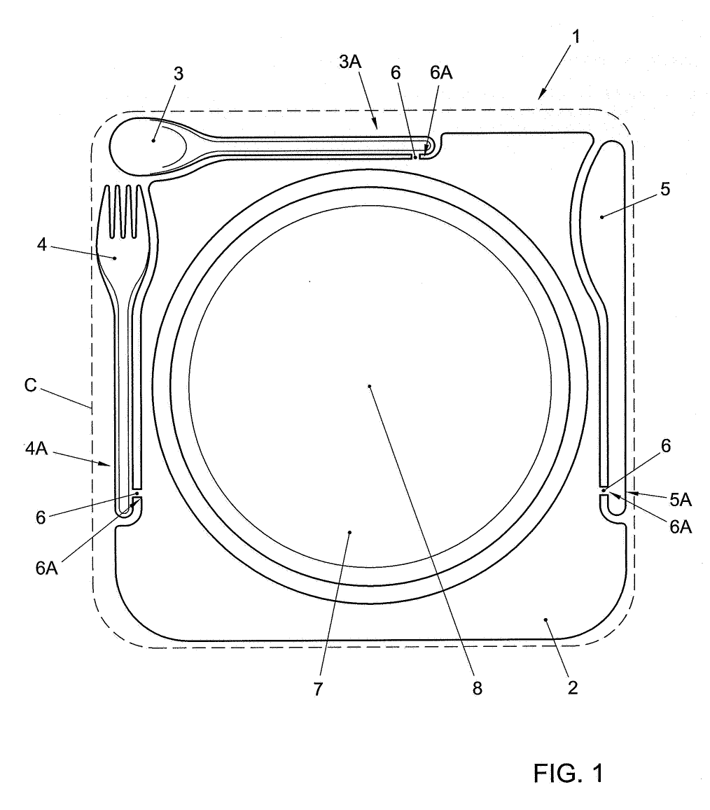

FIG. 1 shows a set of eating and/or drinking aids in top plan view;

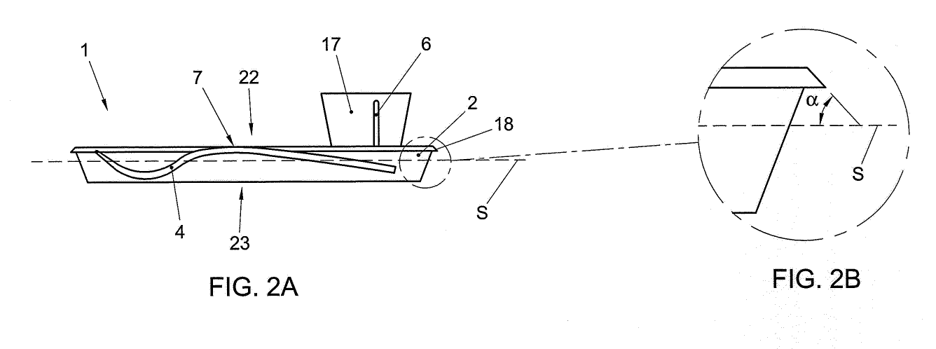

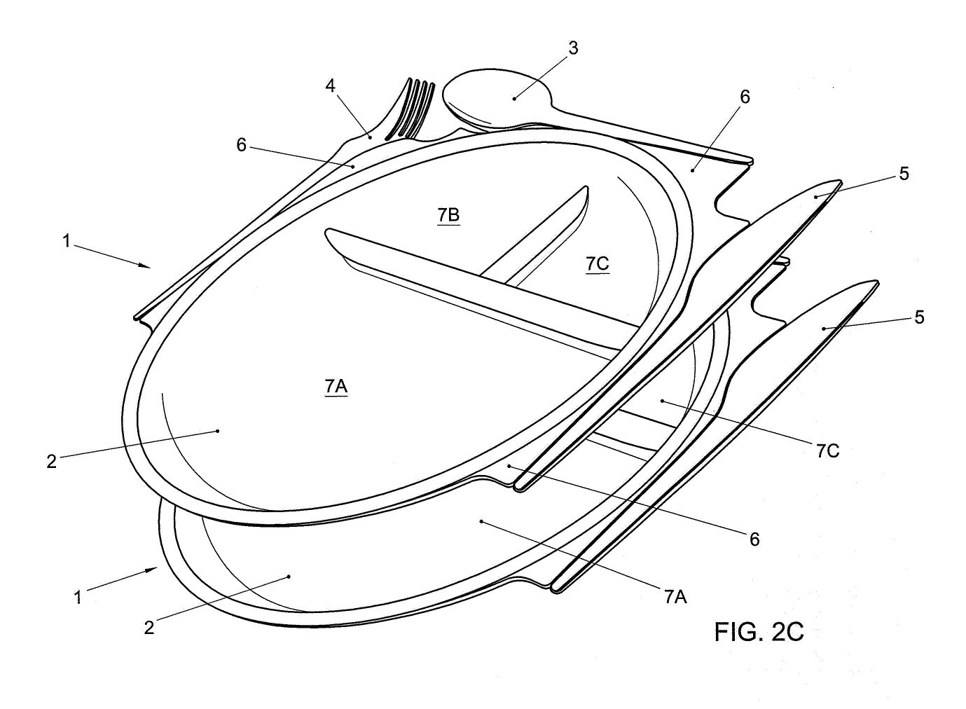

FIG. 2A shows a set of eating and/or drinking aids in side elevational view;

FIG. 2B shows a detail of a set of eating and/or drinking aids in side elevational view;

FIG. 2C shows two sets of eating and/or drinking aids in perspective;

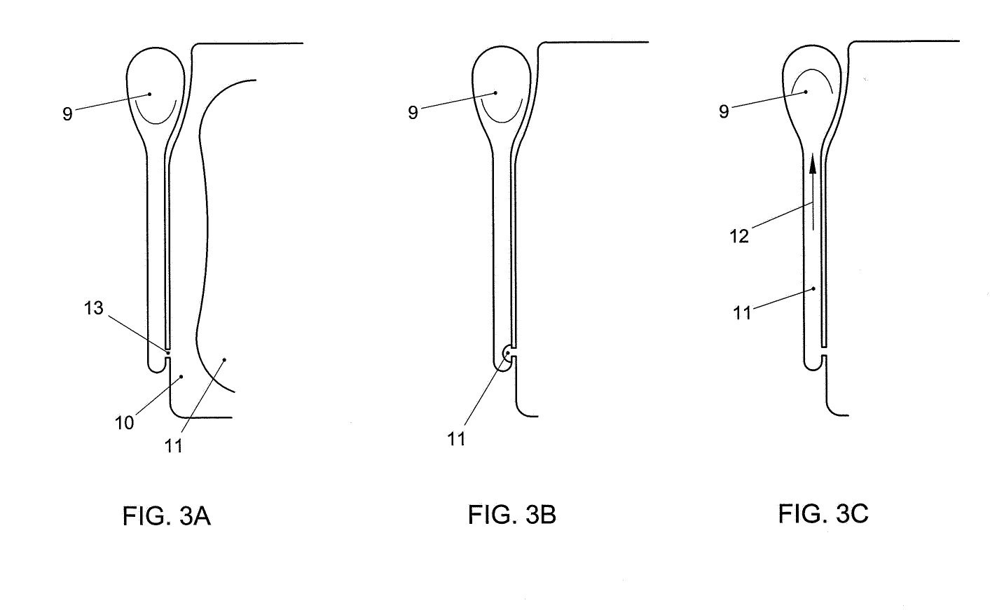

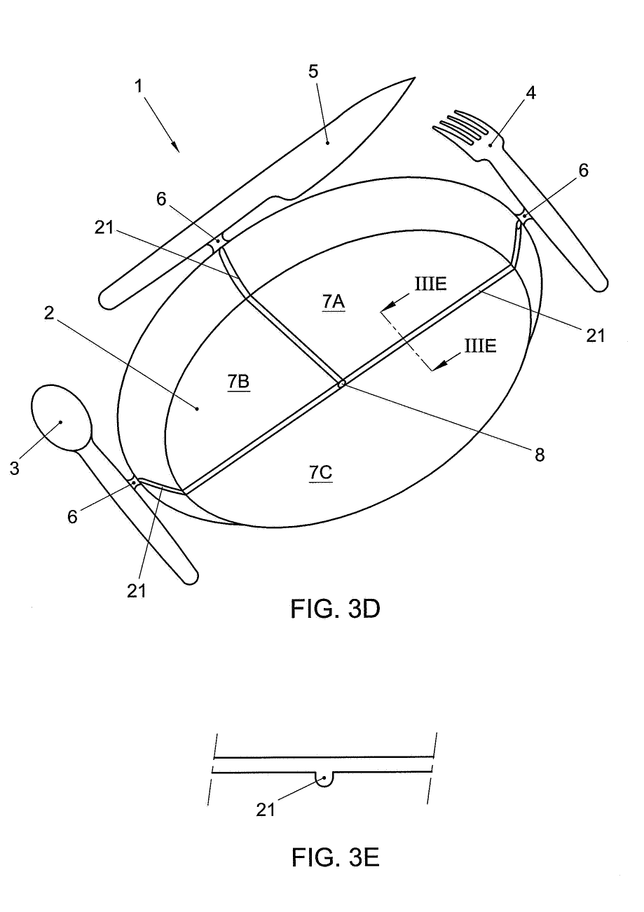

FIG. 3A shows a schematic detail representation of a cross section of a mold for a set of eating and/or drinking aids in front view at a first point in time in an injection molding process;

FIG. 3B shows a schematic detail representation of a cross section of a mold for a set of eating and/or drinking aids in front view at a second point in time in an injection molding process;

FIG. 3C shows a schematic detail representation of a cross section of a mold for a set of eating and/or drinking aids in front view at a third point in time in an injection molding process;

FIG. 3D shows a set of eating and/or drinking aids in perspective;

FIG. 3E shows a detail representation of a cross section from FIG. 3D;

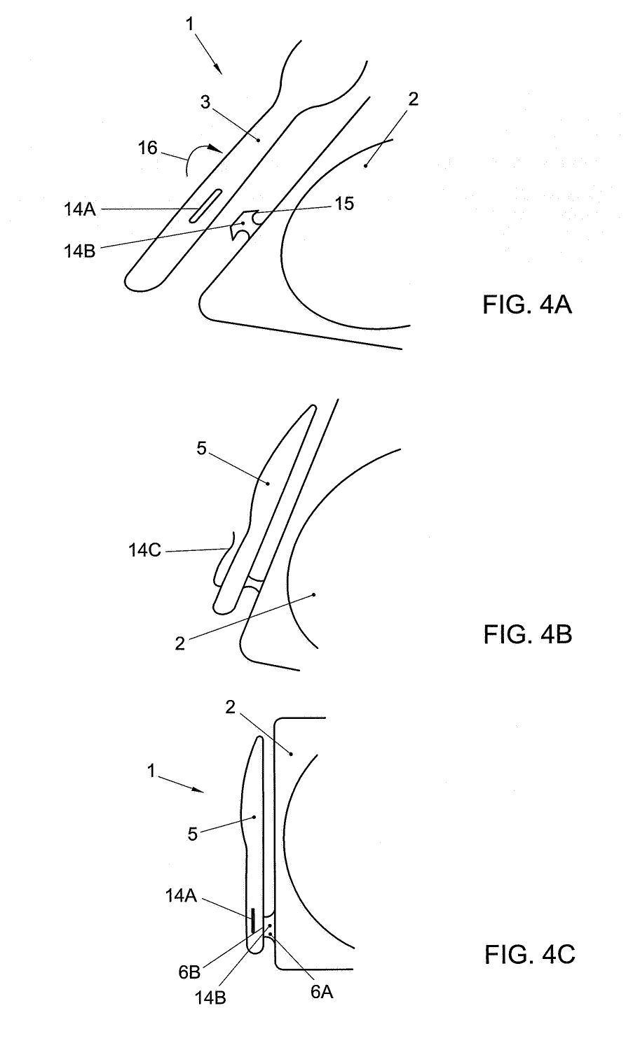

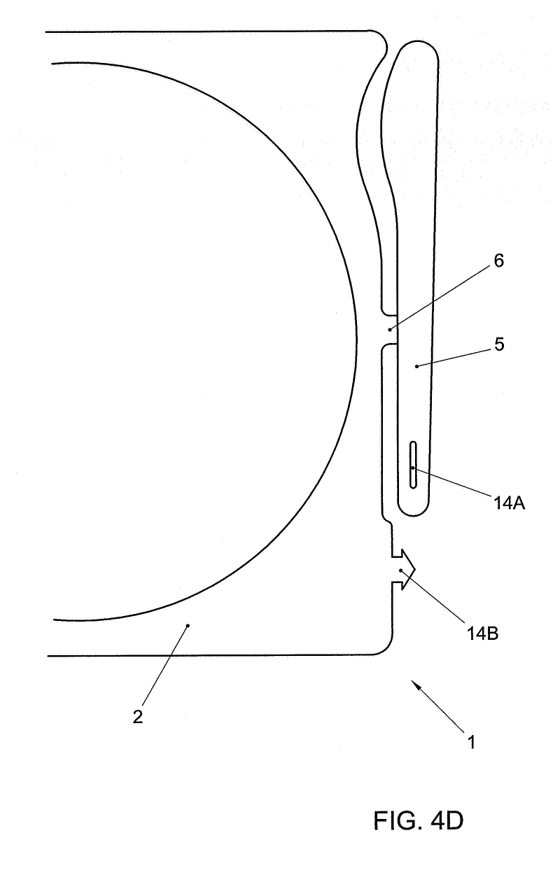

FIG. 4A shows a detail representation of a set of eating and/or drinking aids in perspective;

FIG. 4B shows a detail representation of a set of eating and/or drinking aids in perspective;

FIG. 4C shows a detail representation of a set of eating and/or drinking aids in top plan view;

FIG. 4D shows a detail representation of a set of eating and/or drinking aids in top plan view;

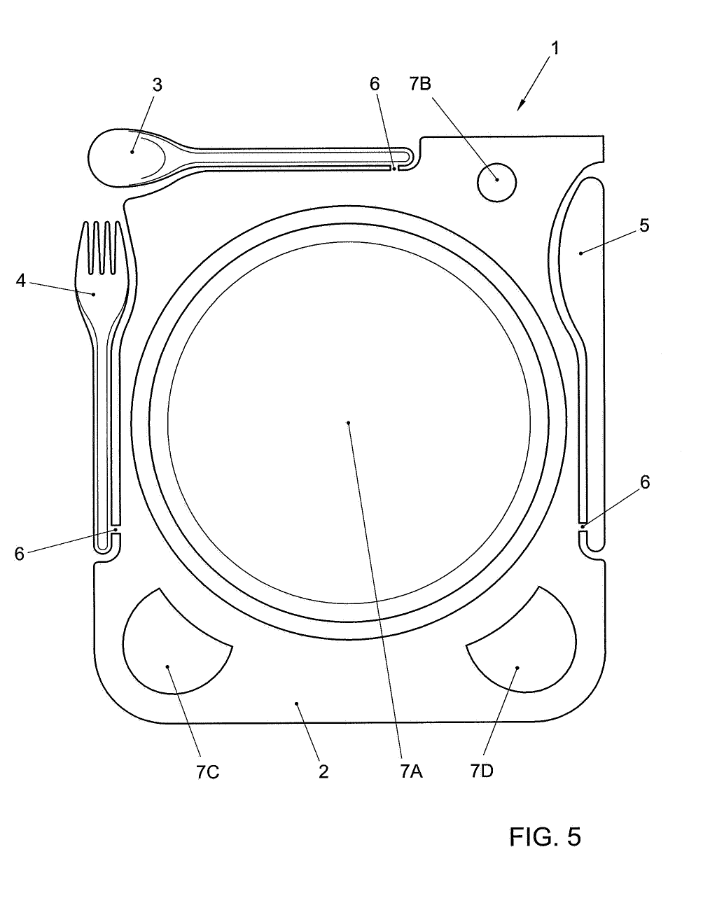

FIG. 5 shows a set of eating and/or drinking aids in top plan view;

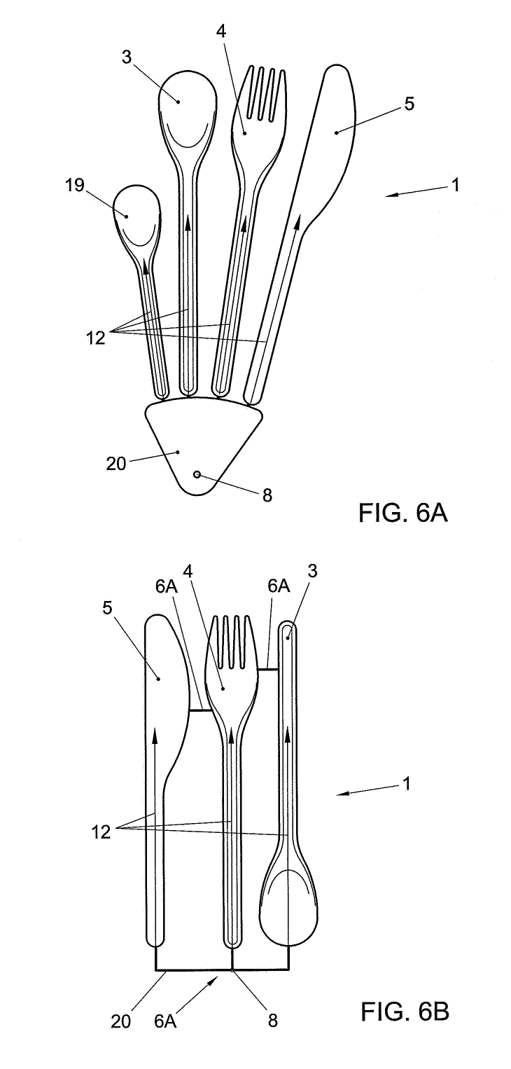

FIG. 6A shows a set of eating and/or drinking aids in top plan view;

FIG. 6B shows a set of eating and/or drinking aids in top plan view;

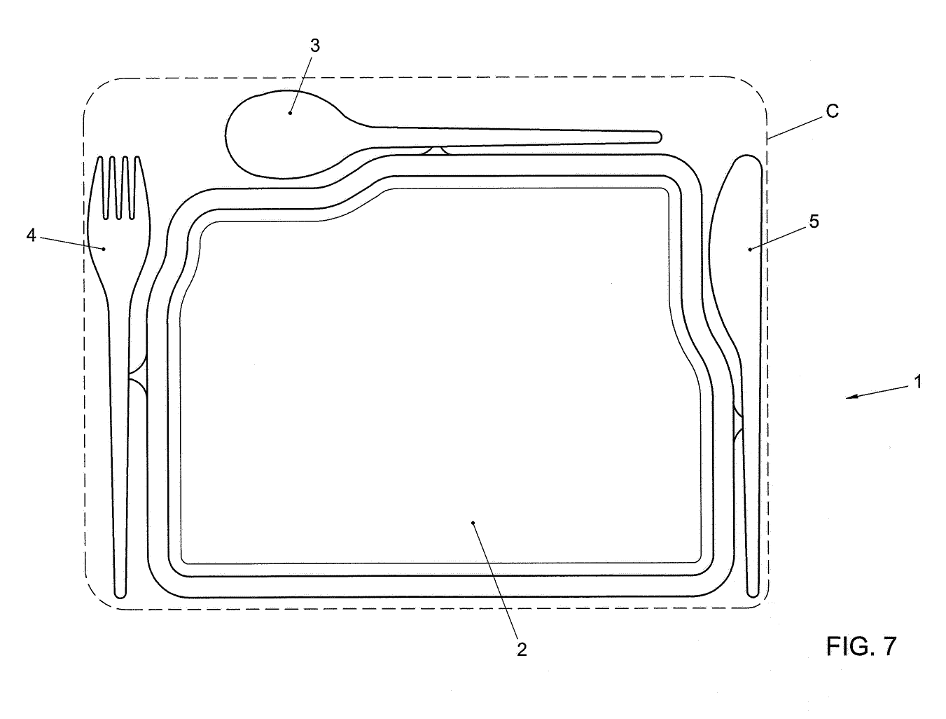

FIG. 7 shows a set of eating and/or drinking aids in top plan view;

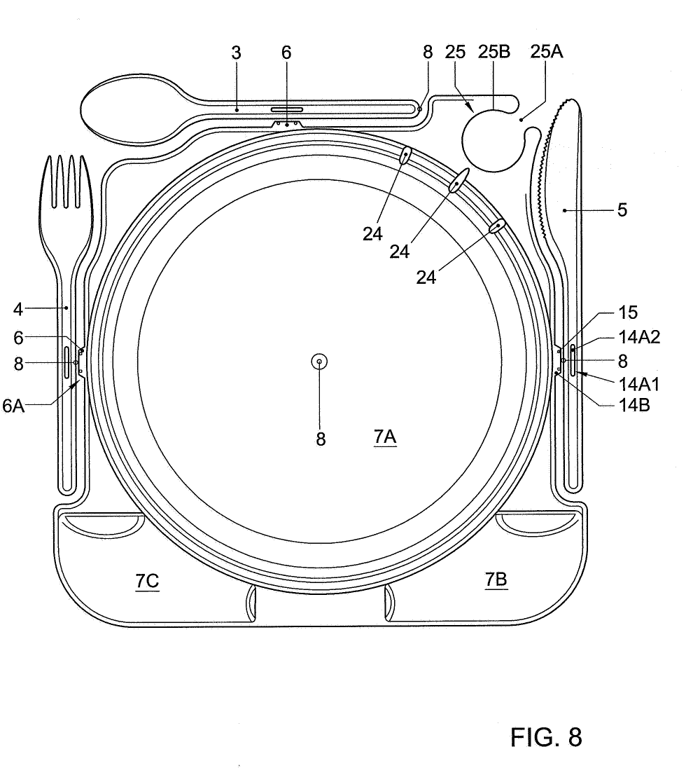

FIG. 8 shows a set of eating and/or drinking aids in top plan view;

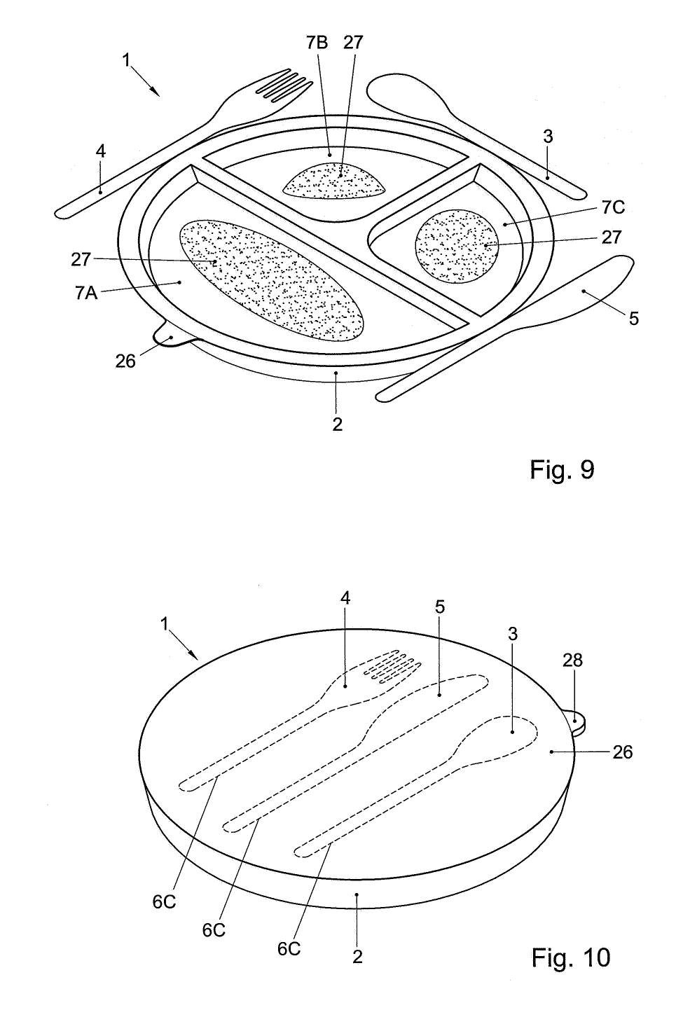

FIG. 9 shows a set of eating and/or drinking aids in perspective;

FIG. 10 shows a set of eating and/or drinking aids in perspective;

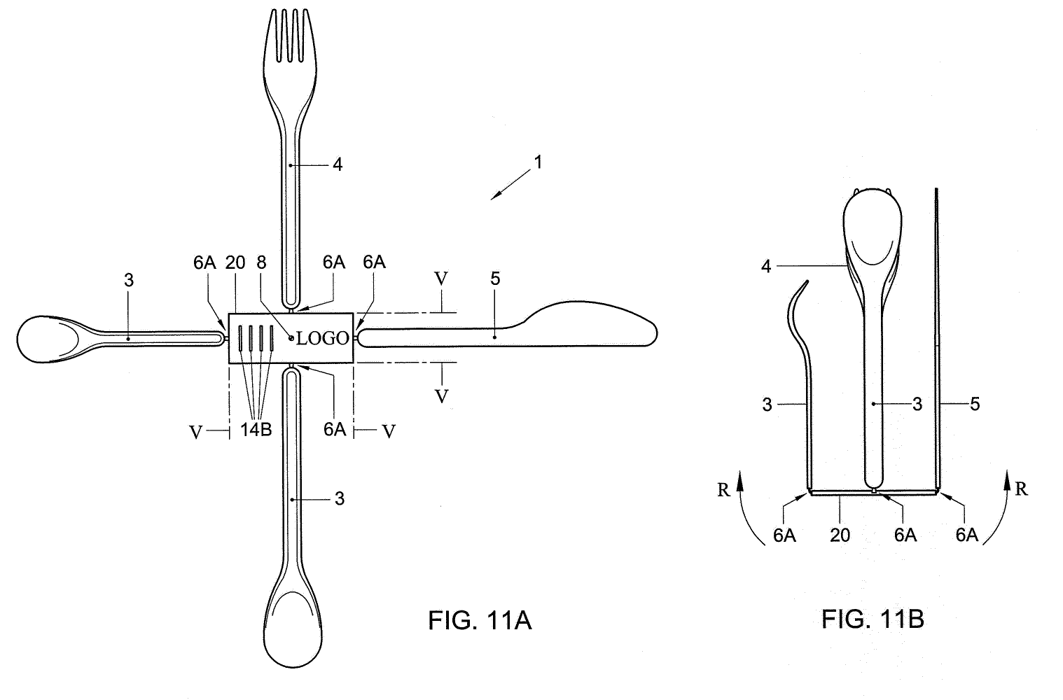

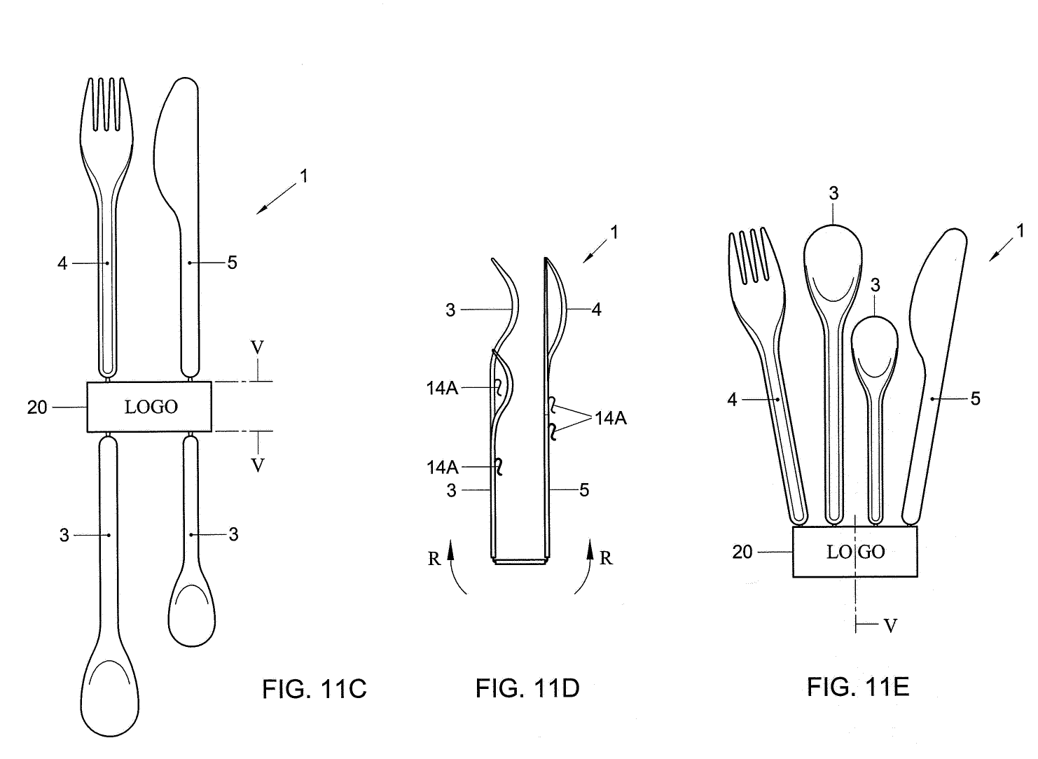

FIGS. 11A-11E show sets of eating and/or drinking aids in top plan view and side elevational view;

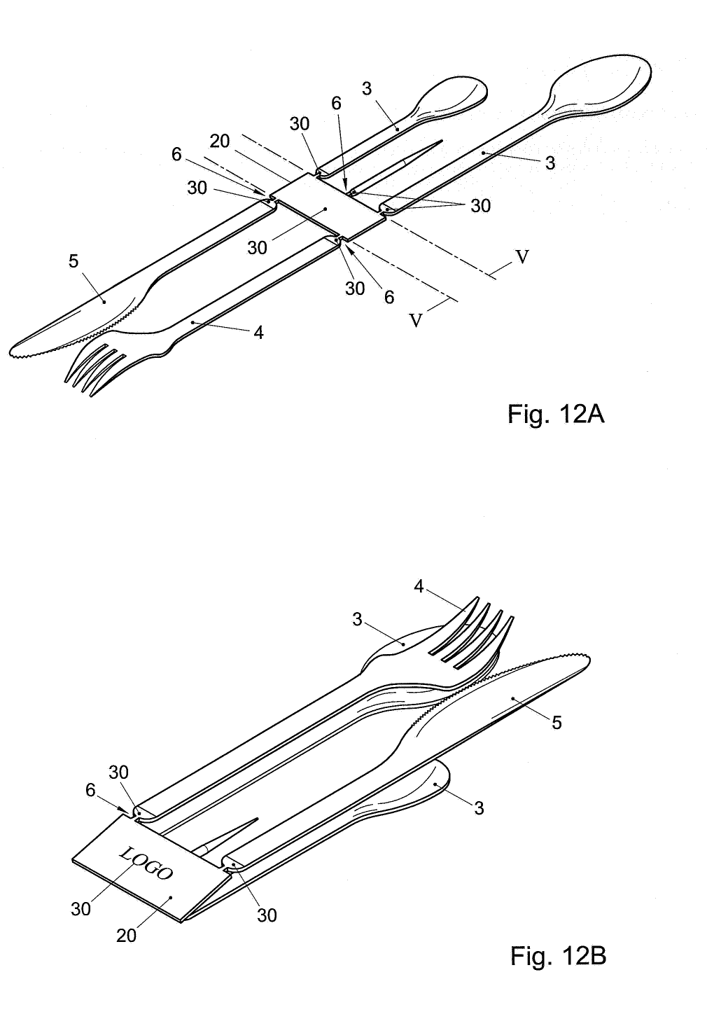

FIGS. 12A and 12B show sets of eating and/or drinking aids in perspective;

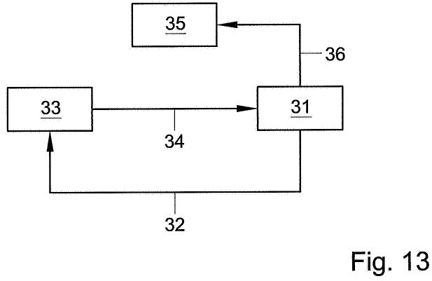

FIG. 13 shows a method for distributing a set of eating and/or drinking aids.

In this description, same or corresponding parts have same or corresponding reference numerals. In the drawing, embodiments are only shown by way of example. The elements used therein of the set of eating and/or drinking aids are only mentioned as an example and should not be taken as being limitative in any way. Other parts of the set of eating and/or drinking aids can also be used within the framework of the invention. The proportions of the embodiments shown in the Figures are mostly schematic and/or exaggerated and should not be taken as being limitative in any way.

FIG. 1 shows an embodiment of a set of eating and/or drinking aids 1 according to the invention. In this description, a set of eating and/or drinking aids 1 will be referred to as a “set” 1. This set 1 is provided with eating and/or drinking aids, comprising cutlery units 3, 4, 5 and a plate 2 with a recess 7. In the recess 7, for instance, packaged or non-packaged food can be served. On the outside of the plate 2, the cutlery units 3, 4, 5 are coupled by means of connecting pieces 6, which cutlery units 3, 4, 5 comprise a spoon 3, fork 4 and knife 5.

In this description, reference will often be made to the spoon 3, fork 4 and knife 5 conventional by Western standards, but it is to be understood that, in addition and/or instead, other eating and/or drinking aids may be used as well. Further, other means can be breakably coupled to the eating and/or drinking aids, such as for instance, but not exclusively, space for logos, publications, etc.

When one proceeds to use the set 1, the required cutlery units 3, 4, 5 can be broken off. The connecting pieces 6 form such a connection that the cutlery units 3, 4, 5 can be broken off approximately at the location of and/or near the connecting piece 6 in order to allow them to be uncoupled from the plate 2. Perhaps unnecessarily, it is noted here that it is also possible that some material of the plate 2 or a cutlery unit 3, 4, 5 can tear away, but the functionality of the respective eating aid will be substantially maintained.

As is shown in FIG. 1, the cutlery units 3, 4, 5 are attached on the outside along the plate 2. In this way, the cutlery units 3, 4, 5 are relatively easy to remove from the plate 2. In particular embodiments, the cutlery units 3, 4, 5 are coupled on the outside in twos, with, for instance, a knife 5 being coupled to the plate 2 and the spoon 3 to the knife 5.

In the embodiment of FIG. 1, the set 1 shows an outer contour C, shown here by a dotted line, which outer contour substantially has the shape of a rounded rectangle, so that the set 1 can, for instance, be stored, transported and/or placed next to and/or on top of one another relatively easily, with relatively little empty space. Differently shaped outer contours C are also conceivable, for instance, but not exclusively, a circle, ellipse, trapezoid, the outer contours of particular logos, trademarks and/or designs, etc.

For storage, transport and/or placing next to and/or on top of one another with relatively little empty space of the set 1, it is favorable if the eating and/or drinking aids of set 1 are configured in a flat position relative to one another. As can be seen in side elevational view in FIG. 2A, the eating and/or drinking aids of the set 1, where only a fork 4, plate 2 and cup 17 are indicated, are disposed relatively flat with respect to an imaginary intersecting plane S, indicated by a dotted line. Also, a relatively flat position may here be understood to mean, for instance, a serving position and/or lying position. The intersecting plane S intersects all or most eating and/or drinking aids so that a relatively flat arrangement of the set 1 can be achieved.

For the purpose of nestability of multiple sets 1, a top side 22 and a bottom side 23 of the set 1 have approximately the same shape. As a result, a bottom side 23 of a first set 1 fits on the top side of a second set 1. Further, the recesses 7 help prevent the stacked sets 1 from shifting with respect to one another. In one embodiment, also, stacking edges 18 are provided on the eating and/or drinking aids, rendering it more difficult for the stacked sets 1 to shift relative to each other. The stacking edges 18 may, for instance, be at an angle a with respect to the imaginary intersecting plane S, as can be seen in enlargement in FIG. 2B. This angle may, for instance, be between 15 and 89°. While maintaining the nestability, multiple recesses 7A, 7B, 7C can be formed, for instance for sauces, as shown in FIG. 2C. Since in embodiments with cups 17 favorable stacking may be more difficult, the set 1, for the benefit of nestability, may be provided near the cup 17 with a specially configured connecting piece 6C which allows a connecting piece 6C of a first set 1 to be slid over a connecting piece 6C of a second set 1.

The whole set 1 is preferably integrally manufactured from plastic by means of an injection molding process, for instance from PS (polystyrene) since PS is a relatively inexpensive material. In addition, PS is relatively simply biodegradable. Further, PS typically has such a strength as to allow for instance the cutlery unit 3, 4, 5 to be broken off the plate 2 relatively simply. To this end, PP (polypropylene) is also a suitable material.

By using, for instance, one injection point 8 in the injection molding process, a relatively inexpensive manner of manufacture is achieved, although the invention should not be limited thereto. It is favorable to position this injection point 8 approximately near the center of the set 1, at least in the embodiment shown in FIG. 1 the plate 2, so that upon injection the plastic flows relatively uniformly from the center of a mold cavity part 10 corresponding with the plate 2 (FIG. 3a) outwards, i.e. without obstacles of mold cavity parts or objects along the way. Thus, relatively short injection molding cycle times can be achieved.

In one embodiment, the connecting pieces 6 are designed as flow bridges 6A (see FIG. 1) which are arranged near the ends 3A, 4A, 5A of the cutlery units 3, 4, 5. This is favorable because then, during the injection molding process, the plastic 11 will fill the mold cavity part 9 corresponding with the respective cutlery unit 3, 4, 5 substantially in one direction 12, as schematically shown in detail in three steps in FIGS. 3A-C. FIG. 3A shows how the plastic 11 flows, for instance from the center of the mold cavity part 10 corresponding with the plate 2, in the direction of the mold cavity part 13 corresponding with the flow bridge 6A. FIG. 3B shows how, after the plate-shaped mold cavity part 10 has at least to a large extent been filled, the plastic 11 flows through the flow bridge-shaped mold cavity part 13 into spoon-shaped mold cavity part 9. FIG. 3C shows the direction 12 along which the plastic 11 fills the spoon-shaped mold cavity part 9. By this filling in the substantially uniform direction 12, a relatively uniform filling of the spoon-shaped mold cavity part 9 is achieved, which is favorable to the quality and/or the relatively uniform density of the end product. Further, a relatively uniform curing process will occur. If a mold cavity part 9 is filled in multiple directions, then, in an unfavorable manner, for instance a less uniform density of at least parts of the end product may be achieved than with the present embodiment. The location of the flow bridges 6A near the above-mentioned ends 3A, 4A, 5A is also favorable because the user will then be less troubled by the breaking points created after breaking off the cutlery units 3, 4, 5 when using the cutlery units 3, 4, 5. It is therefore preferred to place the flow bridges 6A near the handles rather than near the part of the cutlery units 3, 4, 5 that will be near or against the mouth of a user, such as for instance the convex part of the spoon 3.

FIG. 3D shows a set 1 where flow channels 21 are provided in a bottom of the plate 2. From the injection point 8, for instance, multiple flow channels 8 extend in the plate 2 in the direction of the flow bridges 6A. Through mold cavity parts corresponding with these flow channels 21, the plastic 11 will be able to move relatively fast in the direction of the mold cavity parts 9 corresponding with the cutlery units 3, 4, 5, so these mold cavity parts 9 can be filled relatively fast. FIG. 3E shows an example of a detail with a cross section of a flow channel 21. With the flow channels 21, the plastic finds a relatively free passage to the flow bridge 6A and less or no rise of pressure is needed for filling the mold cavity part 9. In contrast with, for instance, plates 2 without flow channels 21, where the pressure increases at a given moment, i.e. at the moment that the plastic 11 has spread up to the flow bridges 6A, since the mold cavity part 9 is to be filled from multiple directions along the flow bridge 6A. The flow channels 21 are also suitable as strengthening ribs 21 to provide the plate 2 with extra strength. Further, the flow channels 21 may favorably serve as partitions, with which three recesses 7A, 7B, 7C are formed, for instance for sauces and/or salads.

In an alternative embodiment, the set 1 has multiple injection points 8, which is, for instance, shown in FIG. 8. Thus, in the production process, multiple parts can be injected separately, for instance using hot runners. In such a manner, each separately injected part is injected in an efficient manner. By use of multiple injection points 8, better control of the injection molding process can be obtained. Thus, for instance, a uniform flow or distribution of the plastic over the set 1 can be obtained. Further, the multiple injections 8 and in particular the positioning of the injections 8 are arranged to suitably injection-mold the different parts of, for instance, different wall thicknesses, volumes, shapes, colors and/or other properties which are preferably different from part to part. One embodiment has, for instance, at the location of a thickening, a separate injection point 8, for instance at the transition between plate 7 and cutlery unit 4, at the connecting piece 6. Thus, for instance, for the distinction between different parts, it may be advantageous if different parts are designed in different colors. For instance, the cutlery units 3, 4, 5 and the plate 2 are designed in different colors, and/or the cutlery units 3, 4, 5 are mutually designed in different colors. Thereby, it can more clearly be indicated that the integrally molded set 1 actually comprises multiple parts. This can be realized in an advantageous manner by means of different injection points 8. The positioning and the number of the injection points 8 can be chosen in a functional manner. Further, it is advantageous if an injection point 8 is chosen near an end of a cutlery unit 3. This is, for instance, favorable for the flow properties of the plastic.

By the use of multiple injection points 8, further, a stronger construction can be achieved. For instance, by multiple injection points 8, the creation of a kind of bottleneck at a breaking edge at a connecting piece 6 can be avoided. A cutlery unit 3, 4, 5 may, for instance, be injected separately from the plate 2. This offers, for instance, the possibility of setting the production process such that the convergence of the plastic flows of multiple parts, for instance of a cutlery unit 3, 4, 5 and a plate 2, converges at the location of a breaking edge and/or connecting piece 6. Thus, for instance, in an advantageous manner, each part can be injected in a different color, without disadvantageous color running in disadvantageous places.

The multiple injection points 8 can be positioned optimally, for instance, an injection point 8 of a part can be chosen at the location of a breaking edge and/or connecting piece 6, so that the respective part is injected from the injection point 8. At the location of an injection point 8, for instance at a breaking edge, for instance, partitions may be provided, i.e. a kind of temporary closing valves, placed in the mold, which ensure that the colors of the different parts do not mix too much. For instance, these partitions are only opened, i.e. withdrawn, last in the injection molding process, for connection and/or junction with the plastic flows of the different parts. The principle of multiple injection points 8 can, in principle, be applied to all embodiments discussed in this description. With multiple injection points 8, further, relatively short cycle times can be realized.

In one embodiment, the set 1 is provided with fastening means 14A, 14B for coupling the cutlery units 3, 4, 5 with the plate 2. Thus, in a favorable manner, after breaking off the cutlery unit 3, 4, 5, the set 1 can still be kept together and then be detached without breaking off. FIGS. 4A and 4D show an embodiment where the fastening means comprise a notch 14A and a cam 14B corresponding therewith in order to couple the spoon 3 to the plate 2. For use of this cam 14B and notch 14A, the spoon 3, after it has been broken off in a direction 16, is rotated approximately about its axis, or in an opposite direction, until the notch 14A can be slid relatively simply around the cam 14B. In one embodiment, the notch 14A is, for instance, approximately perpendicular to the connecting piece 6 so that the spoon 3 needs to be rotated about 90° for connection with the plate 2. In this embodiment, the cam 14B comprises two projections 15 which clamp the plate 2 in the spoon 3 if the cam 14B is slid into the notch 14A. Such notches 14A and cams 14B can relatively simply be injection-molded integrally with the set 1. Other fastening means 14 are also conceivable, for instance a cutlery unit 3, 4, 5 can be provided with a clip 14C for coupling with the plate 2, as shown in FIG. 4B. Further, for instance, the connecting piece 6 may serve as a type of cam 14B, as can be seen in FIG. 4C. If, for instance, the connecting piece is broken off at the breaking point 6B near the cutlery unit 5, a part of the connecting piece 6A remains as cam 14B, for coupling with a slot 14A. Further, it is possible to connect the cutlery units 3, 4, 5 with the outside of the plate 2 at any point.

As is shown in FIG. 5, in particular embodiments, multiple recesses 7A, 7B, 7C, 7D are provided, for instance for sauces or other substances. These or some of these recesses 7A, 7B, 7C, 7D may, for instance, be provided with a cover film 26 and/or another cover element 26 for the purpose of the freshness of a product supplied therewith and/or hygiene.

In an advantageous embodiment, the flow bridges 6A are arranged at the end of the cutlery units 3, 4, 5, 19, so that substantially one flow direction 12 is achieved. The cutlery units 3, 4, 5, 19 may be coupled by means of a strip 20, as can be seen in FIG. 6A. By placing the injection point 8 opposite the end of these flow bridges 6A, substantially one flow direction 12 is achieved per cutlery unit 3, 4, 5, 19. As already described, this is favorable to the strength of the cutlery units 3, 4, 5,19 of the set 1, so that the cutlery units 3, 4, 5, 19 can relatively easily be broken off the strip 20 without breaking the cutlery units 3, 4, 5, 19 themselves. In order to promote such a favorable process, in the embodiment shown, the cutlery units 3, 4, 5,19 are arranged more or less in a ‘fan shape’. This means that the centerlines M of the cutlery units 3, 4, 5, 19 extend approximately from one point and are at a relatively small angle with respect to one another, for instance, but not exclusively, about 3° to 20°. This point may, for instance, be near the injection point 8, by which a uniformly directly flow can be promoted. The injection point 8 may, for instance, be positioned in the strip 20, which connects the flow bridges 6A with each other and on which information can be shown in a favorable manner, such as for instance a logo.

In another embodiment, as shown in FIG. 6B, the cutlery parts 3, 4, 5 are coupled together with one flow bridge 6A, while optionally additional flow bridges 6A are provided to add stability in the set 1. Here, a favorable flow direction 12 can be provided as well.

FIG. HA shows an embodiment where cutlery units 3, 4, 5 are coupled to a strip 20, which strip 20 is, for instance, provided with a logo. Also, for instance, an eating and/or drinking aid and/or another aid can be placed within the strip, such as for instance a toothpick, for instance also by means of flow bridges 6A. Instead of a strip 20, the cutlery units 3, 4, 5 may also be interconnected by means of a connecting piece 6/flow bridge 6A, for instance without logo. Also, the strip 20 can take all kinds of shapes, for instance other than rectangular, for instance in the form of a logo or mascot or the like.

Just after the plastic molding process, the cutlery units and the strip 20 are, for instance, positioned as can be seen in FIG. 11A. As shown, the cutlery units 3, 4, 5 are arranged opposite one another around the strip 20, in other words, they extend in line with one another. Thus, the injection point 8 is, for instance, approximately in the center and/or on the strip 20 so that the flow direction 12 of the plastic is directed from the inside outwards, through the parts 3, 4, 5 and, for instance, along the flow bridges 6A. In other embodiments, for instance, multiple injection points 8 are in different positions of the cutlery units 3, 4, 5, for instance near the flow bridge 6A and/or near the end of the cutlery units 3, 4, 5. Multiple injection points 8 make it possible to injection-mold the cutlery units 3, 4, 5 and/or the strip 20 in different colors.

After the set 1 has been molded, the cutlery units 3, 4, 5 can be brought together in a favorable manner by folding these inwards over folding lines V, i.e. through an angle of about 90°, in a direction R, as can be seen in FIG. 11B. The folding line V is, for instance, provided in or near a connecting piece 6 and/or the strip 20. In the condition folded inwards, the set 1 is relatively compact and may, for instance, be packaged in a packaging and/or film. Here, between the cutlery units 3, 4, 5, there is room for, for instance, a napkin, directions for use or the like. The set 1 may then also be packaged together with other objects, such as for instance pepper and/or salt pots, sugar, etc., after which the whole can be sealed. In a favorable manner, the folding and/or packaging can be mechanized. Now that the folding and packaging of the sets 1 can be mechanized, considerable advantages are achieved compared to conventional disposable cutlery packaging methods, where often relatively much personnel is employed. This is, for instance, the case with conventional disposable cutlery parts in a seal packaging for in airports.

A favorable configuration of the cutlery units 3, 4, 5 can be chosen, where, for instance, the configuration of the folded cutlery units 3, 4, 5 changes as well. This can, for instance, be seen in an alternative embodiment according to the same principle in FIGS. 11C and 11D. FIG. 11C shows that the cutlery units 3, 4, 5 extend opposite one another in line with one another from a top side and bottom side of the strip 20. Here, only two folding lines V are used along the strip, on the top side and the bottom side of the strip 20. The spoons 3 on the one side and the fork 4 and the knife 5 on the other side may, for instance, be folded inwards in a direction R, as shown in FIG. 11D. Also, here, for instance a napkin may be clamped between the cutlery units 3, 4, 5 and the set 1 may be packaged relatively simply. In still another embodiment, all cutlery units 3, 4, 5 are connected with the strip 20 on one side. Here, the folding lines V may, for instance, not run along the strip 20, but through the strip 20. Such an embodiment is shown in FIG. 11E where one folding line V is shown which runs approximately between two cutlery units 3; however, also, for instance three folding lines V could be spread over the strip 20, the folding lines V extending, for instance, between the extensions of the cutlery units 3, 4, 5.

In particular embodiments, it is also possible to (injection-)mold at least two sets 1 simultaneously, for instance by interconnecting the at least two strips 20 of the at least two sets 1 so as to be breakable. Then, a flow bridge 6A is present between the strips 20 of the different sets 1. The sets 1 may then be broken loose from one another before packaging. In the embodiment according to FIG. 11E, for instance, the different sets 1 may be breakably interconnected along the small or large side of the strip 1.

For use, the set 1 is taken from a packaging, if present, and the cutlery units 3, 4, 5 are broken off along the connecting pieces 6 of the strip 20 for use.

In particular embodiments, the cutlery units 3, 4, 5 and the strip 20 are provided with fastening elements 14A, 14B, respectively. The fastening elements 14A, 14B may be provided on cutlery unit 3, 4, 5 and strip 20 and cooperate, or, for instance, be provided only on cutlery unit 3, 4, 5 or strip 20. For instance, the cutlery units 3, 4, 5 are provided with a clip 14A with which the cutlery units 3, 4, 5 can be connected with the strip 20, as shown in FIG. 11D. In another embodiment, the strip 20 is provided with fastening elements 14B, for instance in the form of cutouts through which the cutlery units 3, 4, 5 can be run, for instance as shown in FIG. 11A. The fastening elements 14A and/or 14B can take different forms such as for instance cutouts, clips, cams, etc., and cooperate with one another or not. With the aid of such fastening elements 14A, 14B, it is also possible that, after breaking off the cutlery units 3, 4, 5, the set 1 is kept together and may, for instance, be packaged and/or repackaged.

In addition to cutlery units 3, 4, 5, for instance spoon 3, fork 4 and knife 5, other means are suitable as well, for instance eating and/or drinking aids such as toothpicks, stirring units such as stirring spoons/teaspoons, Asian chopsticks, straws, cups, bowls, dessert dishes, etc., but additions such as ornaments, mascots, advertising, games, vouchers, etc. are also suitable. Functionalities described in the above description for the cutlery units 3, 4, 5 are usually similarly applicable to means mentioned in this paragraph, which functionalities may of course be used separately or in a combination by a skilled person. Thus, for instance, multiple chopsticks may be provided on one side of a sushi plate 2.

Before the set 1 is manufactured in series, mold parts with cavities for the respective eating and/or drinking aids can be exchanged. For instance, a mold part for a cavity for the knife 5 can be exchanged with a mold part for a cavity for a teaspoon 3, while the mold part for the plate 2 remains the same. Thus, all kinds of assemblies of sets 1 according to the invention are applicable with, in principle, one modularly composable mold, comprising multiple exchangeable mold parts. Such exchangeable mold parts are also referred to as ‘inserts’ in the field.

Of course, instead of flow bridges 6A, further, other connecting pieces 6 may be used within the framework of the invention. It is, for instance, possible to use a strip which is relatively thinned with respect to the thickness of the cutlery units 3, 4, 5 and/or plate 2, i.e. recessed material, as connecting piece 6. Along this, the cutlery 3, 4, 5 may also be torn off the plate 2. Further, for instance, perforations may be used.

For instance for hygiene or publication purposes, the set 1 can be packaged as a single piece or stacked in a plurality, in a preferably sterile packaging, for instance in transparent film. In particular embodiments, the set 1 is provided with at least one cover film 26, for instance for covering the filled or non-filled recesses 7, 17. Such films 26 may, for instance, be glued and/or be connected with the set 1 by means of a melting process.

In one embodiment of the invention, during the manufacture of the set 1, a label 30 is molded integrally with the set 1, for instance a so-called in-mold label 30, see FIG. 12A. A process where, in a mold, for instance an injection mold, a label 30 is molded integrally with the product is, for instance, known from WO 01/17744, the contents of which are understood to be incorporated herein by reference. For instance, in such a manner, a label 30 may be provided in the plate 7, the strip 20 and/or the cutlery 3, 4, 5. The label 40 may, for instance, contain a communication such as advertising and/or information. An advantage of the in-mold label 30 is that, with use of the set 1, for instance as an eating and/or drinking aid, the label 30 itself is, in principle, not affected by the food or drink and/or does not mix therewith, so that hygiene is maintained in an advantageous manner. In addition, the printing remains visible for a long time in a favorable manner. This is because, with in-mold labeling, a thin layer of plastic is provided over the label 30. Here, the set 1 with in-mold label 30 can be produced relatively inexpensively and efficiently.

In one embodiment, the label 30 extends over the edge of the strip 20 and/or over the folding line V, as shown in FIG. 12A. For instance, the label 30 further extends over at least a part of the cutlery 3, 4, 5. This yields inter alia the advantage that, when the cutlery units 3, 4, 5, and/or other eating and/or drinking aids such as for instance a toothpick, are bent over a folding line V, the set 1 is strengthened at the connecting pieces 6 by the label 30. With bending, the label 30 will strengthen the connection between the strip 30 and the cutlery 3, 4, 5, also when the formed plastic around it, at least at the connecting pieces 6, has cracked. Here, the label 30 will form a relatively flexible connection. Particularly with use of PS (polystyrene), which is relatively inexpensive and advantageous for use with a set 1 according to the invention, the plastic will simply break upon bending. The label 30 will therefore locally strengthen the connecting pieces 6, for instance manufactured from PS, in a favorable manner, while the cutlery 3, 4, 5 can be relatively simply bent over folding line V.

After bending, the not yet broken or torn label 30, and/or not yet broken plastic extending in or near the label 30, will keep the cutlery 3,4, 5 and the strip 20 together. In use by the end user, the cutlery units 3, 4, 5 can still be broken from the strip 20, by tearing the labels 30. The use of an in-mold label 30 according to above principle greatly simplifies the manufacturing and/or packaging process of the set 1. Here, the set 1 may be manufactured from PS in a favorable manner.

Further, it is advantageous if the set 1 is provided with information by means of the in-mold label 30, with the information containing, for instance, advertising or other communication, which is not related as such to the producer of the set 1 and/or a distributor of the set 1. This is inter alia advantageous since sets 1 are, for instance, distributed by catering companies, airline companies or other companies, so that the sets 1 can reach a desired number of end users and/or can specifically reach a particular target group. The information is, for instance, perceived repeatedly by a same user, for instance each time when taking off a cutlery unit 3, 4 and/or 5, for which hardly any extra effort is needed. The effect of the communication on the set 1 is therefore a good conveyance in quality and quantity. For instance with use in a plane, it is favorable that the user often has little distraction, is in a sitting position, and/or is relatively cooped up, so that he can perceive the communication in a relatively undisturbed manner.

The principle of providing an in-mold label 30 may, for instance, be used as a separate invention with other plates or cutlery with, for instance, non-breakable elements.

The label 30 may, for instance, contain an advertisement or different information and is, for instance, provided on/in the plate 7 and/or the strip 20. For instance, a brand name or the like is advertised on the paper 1, which brand name is managed by, at least related to, a third party. This third party is, for instance, not the producer or the distributor. Thus, on the one hand, different messages related to different third parties may be distributed by the distributor. On the other hand, via a particular distributor, the third party may, for instance, specifically reach a target group. The producer, for instance an injection molding manufacturer, may, for instance, receive the advertisement digitally from the third party and/or the distributor. This results in a communication network in a favorable manner.

The distributor distributes the sets 1 to a particular audience, while the distributor sells and/or rents out, as it were, particular areas on the sets 1, for instance the plate 7 and/or the strip 20, as advertising space to a third party. This third party benefits from reaching this audience, for instance a particular target group. For instance, the sets 1 may be provided with particular advertising in particular numbers and/or for particular periods. Here, the producer can relatively simply adjust the labels 30 in the mold as desired by the distributor and/or for instance another third party.

A scenario can be described with reference to FIG. 13, in which a method for distributing a set of eating and/or drinking aids 1 is shown, where, in this example, a distributor 21 provides a producer 33 with information via a communication network, in step 32, which information is provided on the set 1 by means of a label 30. The information relates, for instance, to the at least one third party or, for instance, to the distributor 31. In an automatic or semiautomatic manner, then the desired communication is provided on the set 1, or at least molded integrally therein, by the producer, by means of the label 30, while the desired amount of sets 1 is delivered to the distributor 31, in step 34. The distributor then distributes the sets 1 to the receiving audience 35, preferably the desired target group, in step 36. The target group will use the eating and/or drinking aids and will, in principle, throw them away after use. In such a manner, a system of communication flows is created where disposable eating and/or drinking aids are hygienically used for conveying information, while no separate extra parts need to be provided, such as for instance folders. In contrast to, for instance, folders or the like, here material in itself intended to be thrown away is used for conveying information/communication. This is more favorable than conveying such information in, for instance, folders, which, in principle, just create extra waste. In an illustrative example, here, the distributor 31 is an airline company, the producer 33 is an injection molding manufacturer, and the third party is, for instance, a tourist attraction in a respective destination. The audience 25 comprises, for instance, airline passengers.

By providing a cover element 26 over the recesses 7, 17, the set 1 additionally serves as a packaging, see for instance FIG. 9. At least one recess 7A-C may then hold a particular edible or potable substance 27 over which a cover film 26 or another cover element 26 is provided. For instance, in this manner, a dish, such as a dessert dish with a spoon 3, knife 5 and/or fork 4 attached thereto is achieved. Further, in this manner, a meal 27, for instance comprising a substance or recipe per different recess 7A-C, can be packaged. The set 1 with the film 26 may be arranged such that, filled with a substance 27, it is suitable for placing in a freezer, cold store and/or microwave, for instance for frozen storage, cool storage and/or preparation, respectively, of the substance 27. Thus, the set 1 is, for instance, suitable as an eating and/or drinking aid and as a packaging, for instance for a ready meal 27.

Instead of a film 26, also other cover elements 26 may be suitable, for instance a lid 26 and/or a cover element 26 suitable for reopening and reclosing of the set 1 as a packaging, see for instance FIG. 10. Such a cover element 26 may be provided in an advantageous manner, for instance by means of an integrally formed connection 28, such as for instance a (film) hinge, or for instance separately, and may thus be integrally formed in an advantageous manner.

The set of eating and/or drinking aids 1 may be integrally formed, for instance molded, preferably injection-molded, including cover element 26 in an advantageous manner. In one embodiment, for instance the cutlery 3, 4, 5 or a part thereof is incorporated in the cover element 26, so that space can be saved. For instance, the cutlery 3, 4, 5 can then be taken out of the cover element 26, for instance pressed and/or pulled, for instance using a breaking edge 6C. Of course, eating and/or drinking aids, such as the cutlery 3, 4, 5, may at least partly be incorporated in the lid 26 while other eating and/or drinking aids are connected with the plate 2.

Non-limiting examples of packaging embodiments of the plate 2 contain, for instance, substances such as soup, fruit, dairy products, ready meals, etc. and/or combinations thereof. The cover elements 26 may, for instance, at least partly be manufactured from metal and/or plastic. Of course, a set 1 may comprise one or more cover elements 26. Further, after taking off the cover element 26, the set 1 may, for instance, be nestable with other sets 1 from which the cover element 26 has been removed.

A plate 2 is also understood to mean a tray, serving tray, sheet, etc., for instance as is illustrated in FIG. 7. Further, in several configurations and amounts, sections/recesses 7 may be provided, for instance for sushi plates, barbecue sauces, etc. Depending on the requirements regarding quality and/or shape, also multiple injection points 8 may be used with a set 1.

Possible uses of a set 1 are for instance, but not exclusively, flying, public transport, barbecues, parties, receptions, etc. Further, the sets 1 may be used for dispensing machines where the sets 1 can be dispensed by a machine, alone or together with food or drink, for instance after inserting and/or paying a particular amount of money, electronically or in coins.

It is further possible that such a set 1 comprises fastening means 14 with which the cutlery units 3, 4, 5 are coupled to the plate without it necessarily being provided with breakable connecting pieces 6. This plastic set of eating and/or drinking aids 1, comprising eating and/or drinking aids 3, 4, 5 and fastening means 14, while the eating and/or drinking aids 3, 4, 5 are intercoupled by means of the fastening means 14 may, incidentally, also be considered an independent invention. Here, the cutlery units 3, 4, 5 may be placed in the desired place on the outside of the plate 2 and be supplied separately in order to be, for instance, coupled afterwards.

FIG. 8 shows an embodiment of the set 1, where the notch 14A1 of the respective cutlery unit 3, 4, 5 is non-continuous, i.e. has a bottom 14A2. This has the advantage that, after passing the flow bridge 6A, the plastic flow can flow more simply along the notch 14A1 through the respective cutlery unit 3, 4, 5, since more flow space is obtained by designing the notch 14A1 to be non-continuous. If the notch continued, the respective cutlery unit 3, 4, 5 could become warped sooner, since a mold part filling the respective notch 14A1 acts as a sort of dam. Further, the construction could locally lose strength. Because the notch 14A1 does not wholly continue, the plastic can flow relatively more easily along the notch 14A1 and a more uniform distribution is made possible. Here, the non-continuous notch 14A1 is arranged to be coupled with the cam 14B after breaking off. Here, the cam 14B projects into the notch 14A1 and the cam is, for instance, also provided with projections 15 so that the cam 14B can be fixed somewhat in this notch 14A1. In one embodiment, the projections 15 extend upwards perpendicular to the plane of the cam 14B, as can be seen in FIG. 8.

Further, one embodiment of a set 1 is provided with holders 24 and/or glass holders 25. Holders 24 are provided so that, for instance, cutlery 3, 4, 5, skewers, spits or similar elongated food aids can partly be laid therein. These holders 24 are, for instance, designed as notches and arranged at the edge of the plates 2, so that these elongated aids may, for instance, rest therein by their ends. Further, a glass holder 25 may be arranged at the edge of the plate 2, for instance according to the principle as shown in FIG. 8. This glass holder 25 is, for instance, provided with a passage 25A, through which a base of a glass can be led, and a ring-shaped support 25B, on which the spherical part of the glass can rest. These glass holders 25 are eminently suitable for wine glasses but may, of course, also be suitable for suspending and/or supporting other elements such as for instance other glasses, cutlery, skewers with meat, etc.

The described variations and many similar variations, as well as combinations thereof, are understood to fall within the framework of the invention set forth in the claims. Of course, different aspects of different embodiments and/or combinations thereof may be combined with one another and exchanged within the framework of the invention. Thus, the invention should not be limited to only the above-mentioned embodiments.

1. A plastic set of eating and/or drinking aids, comprising eating and/or drinking aids and connecting pieces, wherein the eating and/or drinking aids are breakably intercoupled by means of the connecting pieces.

2. A set of eating and/or drinking aids according to claim 1, wherein the eating and/or drinking aids are included in a relatively flat condition with respect to one another and intersect substantially one imaginary intersecting plane.

3. A set of eating and/or drinking aids according to claim 2, wherein at least a part of the top side and apart of the bottom side of the set of eating and/or drinking aids 1 have approximately the same shape, for the benefit of the nestability of multiple sets on top of one another, wherein preferably at least a part of the set of eating and/or drinking aids comprises stacking edges from the plate surface which are at an angle of 15-89″ with respect to said intersecting plane.

4. A set of eating and/or drinking aids according to claim 1, wherein the eating and/or drinking aids comprise at least one plate.

5. A set of eating and/or drinking aids according to claim 1, wherein the eating and/or drinking aids comprise at least one cutlery unit, for instance at least one fork, knife and/or spoon.

6. A set of eating and/or drinking aids according to claim 4, wherein the at least one cutlery unit and/or at least one other eating and/or drinking aid is coupled to the plate on the outside.

7. A set of eating and/or drinking aids according to claim 1, wherein the eating and/or drinking aids comprise fastening means for detachably interconnecting the eating and/or drinking aids.

8. A set of eating and/or drinking aids according to claim 7, wherein the fastening means are provided with a earn, a notch and a. breaking edge, wherein the breaking edge breakably connects the cam of an eating and/or drinking aid with another eating and/or drinking aid and wherein said other eating and/or drinking aid is provided with a notch, wherein the cam is arranged to be inserted into said notch tor interconnecting said eating and/or drinking aids.

9. A set of eating and/or drinking aids according to claim 8, wherein a cutlery unit comprises a. notch and a plate comprises a cam.

10. A set of eating and/or drinking aids according to claim 8, wherein the notch is non-continuous.

11. A set of eating and/or drinking aids according to claim 1, wherein the set of eating and/or drinking aids is manufactured by means of an injection molding process.

12. A set of eating and/or drinking aids according to claim 11, wherein an injection point of the set is located near an outside and/or the center of the set of eating and/or drinking aids.

13. A set of eating and/or drinking aids according to claim 1, wherein, for at least two eating and/or drinking aids, at least two injection points are provided, via which separate parts are separately injected.

14. A set of eating and/or drinking aids according to claim 1, wherein flow channels are provided which extend from and or to connecting pieces.

15. A set of eating and/or drinking aids according to claim 1, provided with holders for cutlery units, glasses and/or other eating and/or drinking aids.

16. A set of eating and/or drinking aids according to claim 5, wherein the connecting piece comprises a flow bridge, which is positioned near the end of the handle of a cutlery unit and/or other eating and/or drinking aid, so that the plastic tills the mold cavity part corresponding with the respective cutlery unit and/or other eating and/or drinking aid substantially in one direction.

17. A set of eating and/or drinking aids according to claim 16, wherein at least two cutlery units and/or other eating and/or drinking aids are connected with a strip, wherein preferably the cutlery units and/or other eating and/or drinking aids intersect an intersecting plane and wherein the centerlines of the cutlery units and/or other eating and/or drinking aids approximately intersect one another.

18. A set of eating and/or drinking aids according to claim 17, wherein the injection point is located in the strip and wherein said centerlines approximately intersect said injection point.

19. A set of eating and/or drinking aids according to claim 16, wherein the connecting piece and/or the strip comprises a folding line, for folding, without breaking off, an eating and/or drinking aid about at least approximately 90 degrees.

20. A set of eating and/or drinking aids according to claim 17, wherein the strip comprises a label molded integrally in a mold, which label extends at least over connecting pieces of the strip and the cutlery units.

21. A set of eating and/or drinking aids according to claim 16, wherein at least two eating and/or drinking aids extend in line with one another, at least before they have been folded.

22. A set of eating and/or drinking aids according to claim 16, wherein the eating and/or drinking aids are included in a packaging in folded condition.

23. A set of eating and/or drinking aids according to claim 1, wherein the set of eating and/or drinking aids has a substantially rectangular outer contour, preferably with rounded corners.

24. A set of eating and/or drinking aids according to claim 23, wherein, inside said outer contour, at least two recesses are provided.

25. A set of eating and/or drinking aids according to claim 1, wherein at least one cover element is provided over at least one recess.

26. A set of eating and/or drinking aids according to claim 25, wherein the cover element is connected with a plate by means of a film hinge.

27. A set of eating and/or drinking aids according to claim 25, wherein eating and/or drinking aids are at least partly removably connected with the cover element, and are preferably provided in the cover element.

28. A set of eating and/or drinking aids according to claim 1, wherein an in-mold label is provided, preferably at least in a plate and/or strip of the set.

29. A method for manufacturing a set of eating and/or drinking aids according to claim 1, wherein the set of eating and/or drinking aids is manufactured by means of injection molding and wherein at least two breakably interconnected eating and/or drinking aids are injected via at least two injection points.

30. A method according to claim 29, wherein the set of eating and/or drinking aids is injected by means of hot runners.

31. A method according to claim 29, wherein, near the injection and near a breaking edge of the set of eating and/or drinking aids, a partition is provided in the mold, which partition is withdrawn relatively shortly before the end of the injection molding process so that multiple flow paths touch one another.

32. A method according to claim 29, wherein the mold comprises exchangeable mold parts, wherein an exchangeable mold part comprises a cavity for an eating and/or drinking aid.

33. A method according to claim 29, wherein the eating and/or drinking aids are provided with a label during the injection molding process, in the injection mold.

34. A method according to claim 33, wherein the label is provided with a communication which does not relate to the injection molding manufacturer of the eating and/or drinking aids.
